(19) United States
(12) Patent Application Publication
(10) Pub. No.: US 2010/0092829 A1
(43) Pub. Date: Apr. 15, 2010

(54) GAS ELECTRODE, METHOD FOR MAKING THE SAME AND USES THEREOF

(75) Inventors: Marie-Laure Fontaine, Oslo (NO); Fabrice Mauvy, Canejan (FR); Pascal Lenormand, Toulouse (FR); Jean-Marc Bassat, Cestas (FR); Florence Ansart, Labege (FR); Jean-Claude Grenier, Cadaujac (FR)

Correspondence Address: YOUNG & THOMPSON, 209 Madison Street, Suite 500, Alexandria, VA, 22314, US

(73) Assignees: UNIVERSITE PAUL SABATIER TOULOUSE III, Toulouse Cedex 4 (FR); CENTRE NATIONAL DE LA RECHERCHE SCIENTIFIQUE (C.N.R.S.), Paris (FR)

(21) Appl. No.: 12/520,473

(22) PCT Filed: Dec. 19, 2007
(86) PCT No.: PCT/FR2007/002115

§ 371 Date: Jun. 19, 2009

(30) Foreign Application Priority Data
Dec. 22, 2006 (FR) 0611280

(51) Int. Cl. H01M 8/10; H01M 4/86; H01M 4/88

(52) U.S. Cl. 429/30; 429/40; 427/115

(57) ABSTRACT

A gas electrode includes a plurality of stacked layers (2, 3, 4), wherein the first layer (2) is in contact with a solid substrate (1) while the last layer (4) has a free outer surface to be contacted with a gas, each layer being made of at least one mixed oxide selected from the group including perovskites and Ruddlesden-Popper phases, the micro-structure of the first layer (2) being different from that of the last layer (4), the porosity of the different layers (2, 3, 4) increasing from the first layer (2) towards the last layer (4), and the different layers stacked on each other defining a network of a solid interconnected material between the free outer surface of the last layer (4) and the solid substrate with a total thickness higher than 1 μm. A method for making such an electrode and its use in an electrochemical cell are disclosed.

The invention relates to a gas electrode comprising a plurality of layers stacked on top of one another on the basis of a solid substrate such as a solid electrolyte, the various layers being suitable to enable the passage of reactive species across the thickness of this electrode, and comprising a first layer in contact with said solid substrate and a last layer exhibiting a free outer surface intended to be placed in contact with a gas, notably with a source of gaseous oxygen such as the ambient air. Such a gas electrode—notably an air electrode—can be used, in particular, in order to form an electrode—notably the cathode—of an electrolytic cell, notably a solid-electrolyte electrochemical cell (SOEC), and in particular a solid-oxide fuel cell (SOFC). The invention can also be used in the production of an electrochemical membrane.

Fuel cells are extremely promising devices for producing energy, but the technological optimisation thereof remains to be realized in order to enable their dissemination on a large scale, notably in applications for the general public, in particular in the field of transport or in the field of residential units or industrial premises. One of the problems that is posed with these devices is, in particular, that of the production of electrodes that offer high performance at reasonable temperatures (typically lower than 800° C.), that are stable over time and that exhibit a polarisation resistance that is as low as possible, in any case sufficiently low to enable an acceptable electrical output to be obtained. Moreover, this objective has to be achieved with the use of compatible manufacturing techniques in terms of cost-effectiveness and feasibility, with utilisation on an industrial scale.

This is why these fuel cells, and in particular the gas electrodes of which they are composed, have recently been the object of much research.

For example, solutions have already been proposed aiming to improve the interface between the air electrode and the electrolyte, and/or in order to take into account the differences in composition and in coefficient of thermal expansion between the materials constituting the electrolyte and the electrode.

The materials most commonly envisaged in order to produce such an air electrode are porous ceramics based on oxide with perovskite structure, for example the lanthanum manganites doped with strontium, LSM (WO 99/33134, EP 0 510 820, FR 2 697 947, JP 2006-012764, JP 2005-183279 . . . ). With these materials, at best a area specific polarisation resistance value is obtained of the order of 100 Ω·cm² at 800° C. The solid electrolyte is a dense ceramic, generally based on oxide with fluorine structure, and the anode is a ceramic/porous-metal composite, in general constituted by a ceramic of the same material as that forming the solid electrolyte, in which a metal has been dispersed, for example nickel.

Furthermore, WO 2005/099003 describes a new oxide material that is capable of being used advantageously in order to produce a gas electrode, notably an air electrode forming the cathode of a fuel cell.

Nevertheless, despite all this research, no solution has yet been proposed enabling acceptable values of area-specific polarisation resistance and of service life to be obtained, notably with an operating-temperature range between 400° C. and 800° C.

The invention therefore aims to solve this problem by proposing a gas electrode exhibiting an improved area-specific polarisation resistance and an improved service life, notably for a range of operating temperatures between 400° C. and 800° C.

In particular, the invention aims to propose a gas electrode exhibiting a area-specific polarisation resistance lower than 5 Ω·cm² for an operating temperature lower than 800° C., notably between 650° C. and 800° C.

More particularly, the invention aims to propose such a gas electrode, the costs and techniques of manufacture of which are, compatible with utilisation on an industrial scale.

The invention also aims to propose a method for manufacturing such as electrode, as well as an electrochemical cell incorporating such an electrode and exhibiting the same advantages.

To this end, the invention relates to a gas electrode comprising a plurality of layers stacked on top of one another on the basis of a solid substrate such as a solid electrolyte, the various layers being suitable to enable the passage of reactive species across the width of this electrode, and comprising a first layer in contact with said solid substrate and a last layer exhibiting a free outer surface intended to be placed in contact with a gas, each of said layers being constituted by at least one mixed oxide,

characterized in that:
each of said layers is constituted by at least one mixed oxide chosen from the group constituted by the perovskites and by the Ruddlesden-Popper phases corresponding to the following general formula (I):

Lₙ₊₁₋ₓNi_{n-y}M_{y}O_{3n+1±δ}

where L is an element chosen from the group of the rare earths, Ni represents nickel, M is a transition metal, n is a non-zero integer, x, y and δ are real numbers satisfying the following relations:

0≦x<n+1

0≦y<n

0≦δ≦0.25,
said first layer is constituted by at least one mixed oxide chosen from the group of the Ruddlesden-Popper phases corresponding to formula (I),
the microstructure of said first layer is different from the microstructure of said last layer,
the porosity of the various layers increases from said first layer, the porosity of which is the lowest, to said last layer, the porosity of which is the most substantial,
the various layers stacked on top of one another form a network of interconnected solid matter between the free outer surface of the last layer and the solid substrate, exhibiting a total thickness greater than 1 μm.

An electrode according to the invention is accordingly distinguished from the prior art in particular through the choice of the materials making up the layers that constitute it. The inventors have in fact ascertained that this specific family of materials enables results to be obtained in practice that are astonishingly superior to the other more or less similar materials envisaged hitherto within the context of the production of a gas electrode, and without any precise scientific explanation being able to be given for these surprising results.

In addition, an electrode according to the invention is also distinguished by the fact that the various layers that constitute it exhibit a heterogeneous microstructure—that is to say, a microstructure that varies from one layer to the other. In particular, advantageously and according to the invention, the microstructure of the first layer is different from that of the superposed layer in contact with this first layer. This difference in microstructures is due notably to the fact that the layers are produced by distinct deposition processes, with materials that, although pertaining to the same family (the aforementioned formula (I)), are different (notably on account of different proportions for the various elements constituting the material), and with parameters that are also distinct in terms of thickness, grain sizes of deposited material, pore sizes . . . In particular, in an electrode according to the invention the first layer advantageously exhibits macroscopic characteristics that are on the nanometre scale (that is to say, with dimensions between 1 nm and 1000 nm), whereas the last layer, and more particularly all the layers superposed on the first layer, exhibit macroscopic characteristics that are on the micrometre scale (that is to say, with dimensions between 1 μm and 1000 μm). In particular, in an electrode according to the invention the microstructure of the various layers is such that the porosity increases from the first layer to the last layer. Despite this, the various stacked layers form a network of interconnected solid matter between the free outer surface of the last layer and the solid substrate, so that ionic species and electrons are able to circulate in contact with this network by crossing the thickness of the electrode.

This combination of particular characteristics enables unprecedented results to be obtained, notably in terms of polarisation resistance at low temperature—that is to say, at a temperature between 400° C. and 800° C.

An electrode according to the invention is also advantageously characterized by all or some of the following characteristics:
said last layer is constituted by at least one mixed oxide chosen from the group constituted by the perovskites and the Ruddlesden-Popper phases corresponding to formula (I), and all the other layers are constituted by at least one mixed oxide chosen from the group constituted by the Ruddlesden-Popper phases corresponding to the general formula (I); in other words, only the last layer possibly may be constituted by a perovskite structure or may incorporate at least one mixed oxide exhibiting the structure of a perovskite; in a variant, all the layers are constituted by at least one mixed oxide chosen from the group constituted by the Ruddlesden-Popper phases corresponding to the general formula (I),
elements L and M are the same for all said layers of the electrode,
the difference in microstructures is due to different proportions for the various elements constituting the material—that is to say, the values of parameters n, x, y and δ of formula (I) vary from one layer to the other (whether elements L and M are the same or not); elements L and M are preferably the same for all said layers of the electrode, and the values of the parameters n, x, y and δ of formula (I) preferably vary from one layer to the other;
L is an element chosen from the group constituted by La, Pr, Nd, Sm, Eu, Er and Gd, and M is a transition metal chosen from the group constituted by Fe, Co and Mn,
said first layer is constituted by at least one mixed oxide chosen from the group of the Ruddlesden-Popper phases corresponding to formula (I), with n−x≠1,
for said first layer, (n+1−x)/(n−y)<2,
said first layer is constituted by a mixed oxide of formula L₂₋ₓNiO_{4+δ}, L being chosen from the group constituted by La, Pr, Nd,
said last layer is constituted by a mixed oxide chosen from the group constituted by LNiO₃, L₂₋ₓNiO_{4+δ}, L₃Ni₂O_{7-δ}, and L₄Ni₃O_{10-δ}, L being chosen from the group constituted by La, Pr, Nd,
said first layer is constituted by linked elementary solid particles in contact with one another, the mean size of these elementary particles being less than 300 nm,
the thickness of said first layer is less than 200 nm, notably of the order of 50 nm,
said last layer is constituted by elementary solid particles, forming open pores between themselves and constituting an interconnected network of solid matter across its entire width,
said last layer is constituted by linked elementary solid particles in contact with one another, the mean size of these elementary particles being between 100 nm and 5 μm,
it comprises between two and five layers stacked on the solid substrate, the various stacked layers exhibiting a total thickness between 1 μm and 15 μm,
said first layer exhibits a porosity less than 10% by volume,
said last layer exhibits a porosity greater than 10% and less than 50% by volume,
it exhibits a plurality of layers superposed on said first layer in contact with the solid substrate, the porosity of which increases from said first layer to said last layer,
each of said layers results from at least one deposition chosen from a deposition of slip, a deposition of charged sol, and a sol-gel deposition,
at least one intermediate layer between said first layer and said last layer results from at least one deposition chosen from a deposition of slip and a deposition of charged sol,
said first layer results from at least one sol-gel deposition,
said last layer results from at least one deposition chosen from a deposition of slip and a deposition of charged sol,
amongst the various layers, said first layer exhibits the greatest ionic conductivity,
said first layer is constituted by a material, the ionic conductivity of which is greater than or equal to 10⁻² S·cm⁻¹,
said last layer is formed from a material, the ionic conductivity of which is greater than 10⁴ S·cm⁻¹, and the electron conductivity of which is greater than 50 S·cm⁻¹.

The invention extends to a method for manufacturing an electrode according to the invention. The invention accordingly relates to a method for manufacturing a gas electrode in which a plurality of layers are stacked on top of one another on the basis of a solid substrate such as a solid electrolyte, the various layers being produced in order to enable the passage of reactive species across the thickness of this electrode and comprising a first layer in contact with said solid substrate and a last layer exhibiting a free outer surface intended to be placed in contact with a gas, each of said layers being constituted by at least one mixed oxide, characterized in that:
each of said layers is produced in such a way that it is constituted by at least one mixed oxide chosen from the group constituted by the perovskites and by the Ruddlesden-Popper phases corresponding to the following general formula (I):

Lₙ₊₁₋ₓNi_{n-y}M_{y}O_{3n+1±δ}

where L is an element chosen from the group of the rare earths, Ni represents nickel, M is a transition metal, n is a non-zero integer, x, y and δ are real numbers satisfying the following relations:

0≦x<n+1

0≦y<n

0≦δ≦0.25,
said first layer is produced in such a way as to be constituted by at least one mixed oxide chosen from the group of the Ruddlesden-Popper phases corresponding to formula (I),
said first layer is produced in accordance with a deposition process that is different from the process of deposition with which said last layer is produced, so that:
   the microstructure of said first layer is different from the microstructure of said last layer,
   the porosity of the various layers increases from said first layer, the porosity of which is the lowest, to said last layer, the porosity of which is the most substantial,
the various stacked layers are produced in such a way that they form a network of interconnected solid matter between the free outer surface of the last layer and the solid substrate, exhibiting a total thickness greater than 1 μm.

Advantageously in a method according to the invention, each of the layers of the electrode, notably said first layer and said last layer, is produced in such a way that it is in accordance with all or some of the aforementioned characteristics.

In particular, advantageously and according to the invention said first layer is produced with a deposition process that is different from the process of deposition of the superposed layer in contact with this first layer. Said first layer is deposited on the solid substrate by at least one deposition of sol-gel into which there are mixed, in a solvent, precursor species intended to form at least one mixed oxide, then the suspension is admixed to an organic polymeric matrix, then this mixture is applied onto the solid substrate, then the whole is subjected to a thermal treatment that is suitable to bring about the crystallisation of each mixed oxide and the decomposition of the organic polymeric matrix.

Likewise, advantageously and according to the invention said last layer is applied by carrying out at least one deposition of slip in which a slip is produced containing solid particles of at least one mixed oxide which are dispersed in a liquid medium, then this slip is applied in the form of at least one layer, then the whole is subjected to a treatment that is suitable to bring about the evacuation of the liquid medium. Accordingly, in this variant of the invention said last layer is applied by a deposition of slip.

In a variant, said last layer can also be applied by a deposition of charged sol. In order to do this, advantageously and according to the invention said last layer is applied by carrying out at least one deposition of charged sol in which a suspension is produced containing solid particles dispersed in a liquid medium containing precursors of species intended to form at least one mixed oxide, then this suspension is applied in the form of at least one layer, then the whole is subjected to a treatment that is suitable to bring about the deposition and the crystallisation of the mixed oxides and the evacuation of the liquid phase.

Advantageously and according to the invention, each intermediate layer is applied between said first layer and said last layer by carrying out at least one deposition of slip and/or at least one deposition of charged sol as indicated above. Each layer superposed on said first layer up until the last layer is preferably applied by using the same deposition process (slip or charged sol).

Furthermore, advantageously and according to the invention the solid substrate is a gastight (non-porous) solid electrolyte chosen from the group constituted by ceramics that are conductors of O²⁻ anions and by ceramics that are conductors of protons.

The mixed oxides corresponding to formula (I) are phases of the Ruddlesden-Popper series (Lₙ₊₁NiₙO₃ₙ₊₁). The Ruddlesden-Popper phases are well-known (cf. for example the publication M. Greenblatt: Ruddlesden-Popper nickelates Lnₙ₊₁NiₙO₃ₙ₊₁; structure and properties, Current Opinion in Solid State & Materials Science, 2 (1997) pp. 174-183) and have been the object of studies concerning, notably, their magnetic and electrical properties. It has also been envisaged to use some of these mixed oxides by way of porous electrode (cf., for example, the publication F. Mauvy et al.: Oxygen reduction on porous Ln₂NiO_{4+δ} electrodes, Journal of the European Ceramic Society 25 (2005) 2669-2672). Nevertheless, the best values of polarisation resistance obtained hitherto with these materials for an operating temperature of the order of 800° C. are of the order of 10 Ω·cm².

The inventors have now ascertained with surprise that the use of such mixed oxides chosen from the group constituted by the perovskites and by the Ruddlesden-Popper phases according to formula (I) enables an electrode to be produced in practice that is constituted by various stacked layers as indicated above, and enables this to be done by means of simple and economic industrial processes, of the type constituted by sol-gel deposition and/or deposition of slip and/or deposition of charged sol, while controlling precisely:
the porosity and the porosity gradient in the thickness of the electrode,
the properties of ionic conduction and electrical conduction within the electrode, and therefore its electrical performance data,
the coefficients of thermal expansion of the various superposed layers, in order to make them compatible with one another,
   and while avoiding the formation of harmful phases, notably by virtue of cationic diffusion at the interface between the electrode and the electrolyte in the course of use of the electrode.

An electrode according to the invention exhibits unexpected performance data in terms of stability over time and in terms of polarisation resistance. In particular, an electrode according to the invention may exhibit a polarisation resistance less than 5 Ω·cm², notably of the order of 1 Ω·cm² at 800° C., for an operating temperature lower than 800° C., notably between 650° C. and 800° C.

The invention is, in particular, advantageously applicable for the production of a gas electrode of an electrochemical cell. Consequently, the invention extends to an electrochemical cell comprising at least one gas electrode according to the invention. More particularly, the invention extends to an electrochemical cell of a fuel cell, characterized in that it comprises a solid electrolyte bearing a cathode formed from an air electrode according to the invention.

In an electrochemical cell according to the invention the gas electrode exhibits a plane shape overall or a cylindrical shape overall, notably cylindrical in revolution, or any other shape.

Other characteristics, objectives and advantages of the invention will become apparent in the light of the following description, which makes reference to the examples given below and to the attached Figures, in which:

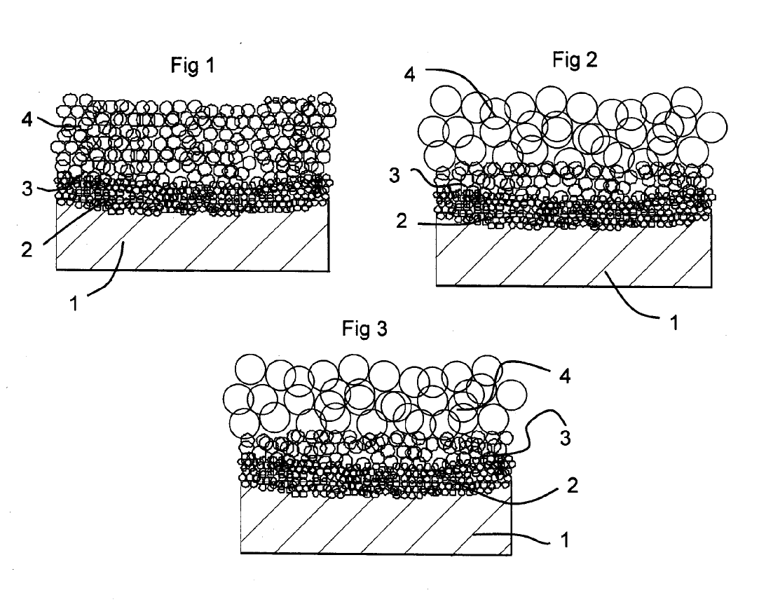

FIG. 1 is a sketch illustrating, in section, a gas electrode according to a first embodiment of the invention,

FIG. 2 is a sketch illustrating, in section, a gas electrode according to a second embodiment of the invention,

FIG. 3 is a sketch illustrating, in section, a gas electrode according to a third embodiment of the invention,

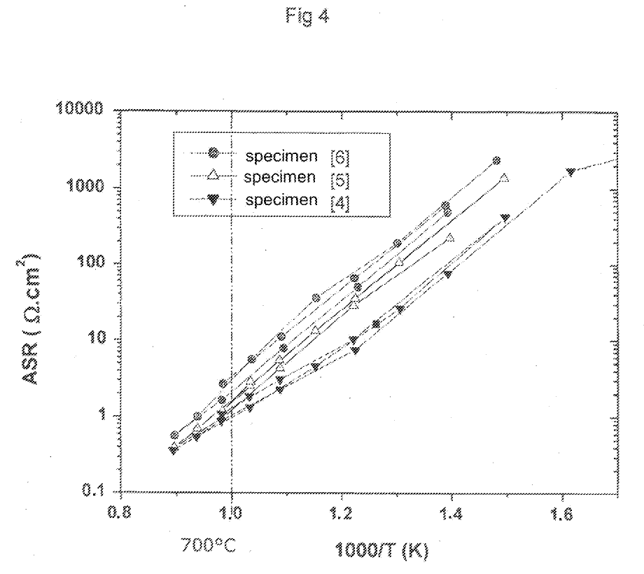

FIG. 4 is a graph illustrating values of area-specific polarisation resistance obtained with different specimens of gas electrodes according to the invention,

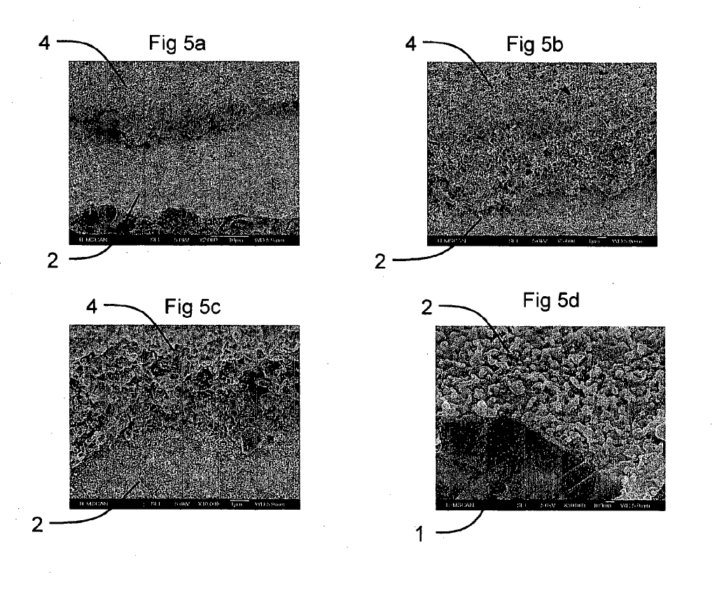

FIGS. 5a, 5b, 5c, 5d are photographs illustrating, at various magnifications, the structure of a gas electrode according to one embodiment of the invention.

A gas electrode according to the invention is constituted by a plurality of layers 2, 3, 4 superposed on top of one another on the basis of a solid substrate 1 constituted by a dense ceramic.

The first layer 2 is constituted by at least one mixed oxide chosen from the group constituted by the Ruddlesden-Popper phases corresponding to the following general formula (I):

Lₙ₊₁₋ₓNi_{n-y}M_{y}O_{3n+1±δ}

where L is an element chosen from the group of the rare earths, Ni represents nickel, M is a transition metal, n is a non-zero integer, x, y and δ are real numbers satisfying the following relations:

0≦x<n+1

0≦y<n

0≦δ≦0.25.

Each of the other layers 3, 4 is constituted by at least one mixed oxide chosen from the group constituted by the perovskites and by the Ruddlesden-Popper phases corresponding to the aforementioned general formula (I). Each of said layers 2, 3 is preferably constituted by at least one mixed oxide chosen from the group constituted solely by the Ruddlesden-Popper phases corresponding to formula (I), with the exception of the last layer 4 which is constituted by at least one mixed oxide chosen from the group of the perovskites and of the Ruddlesden-Popper phases corresponding to formula (I)—that is to say, which may comprise at least one mixed oxide chosen from the group of the perovskites.

The crystallographic structure of the Ruddlesden-Popper phases corresponding to formula (I), which may also be represented by (LO) (Lₙ₋ₓNi_{n-y}M_{y}O₃)ₙ, is formed by n perovskite layers of oxygenic octahedra Ni_{n-y}M_{y}O₆. The atoms of oxygen form a lamina, the structure of which is of NaCl type. The number n represents the number of perovskite layers interlinked by the vertices of the octahedra, and δ represents the number of interstitial atoms of oxygen inserted in the LO layer (cf., for example, the publication M. Greenblatt: Ruddlesden-Popper nickelates Lnₙ₊₁NiₙO₃ₙ₊₁: structure and properties, Current Opinion in Solid State & Materials Science, 2 (1997) pp. 174-183).

In a gas electrode according to the invention the first layer 2 deposited in contact with the solid substrate 1 is formed by a thin film, the microstructure of which exhibits dimensional characteristics that are on the nanometre scale.

The last layer 4, and preferably each of the layers 3, 4 superposed on this first layer 2, is formed of a thicker layer that is produced with a material pertaining to the aforementioned family but that is different, as far as its microstructure is concerned, from the first layer 2. The last layer 4, and preferably each of the layers 3, 4 superposed on this first layer 2, is produced in accordance with a different deposition process and in such a way as to exhibit a microstructure having dimensional characteristics on the micrometre scale.

L is preferably an element chosen from the group constituted by La, Pr, Nd, Sm, Eu, Er and Gd, and M is preferably a transition metal chosen from the group constituted by Fe, Co and Mn.

However, there is nothing to prevent varying the nature of the elements L and M from one layer to the other within the same electrode according to the invention. Nevertheless, advantageously in an electrode according to the invention the elements L and M are the same for all said layers of the electrode. In particular, this results in better chemical affinity, better thermomechanical compatibility and fewer problems linked to the phenomena of diffusion into one another of the elements constituting the electrode.

The solid substrate 1 is a dense solid electrolyte—that is to say, non-porous and therefore gastight. Such a dense solid electrolyte can be chosen from the group constituted by ceramics that are conductors of O²⁻ anions and by ceramics that are conductors of protons. More particularly, the solid substrate 1 is chosen from:
The proton-conducting materials, and in particular those exhibiting one of the following structures:
Perovskite structure AB₁₋ₓMₓO₃:
   ∘ Examples: Ba(Zr,Yb)O₃, Sr(Ce,Y)O₃
Brownmillerite structure: A₂B₂O₅:
   ∘ Example: Sr₂Gd₂O₅
Pyrochlorine structure: A₂B₂O₇
   ∘ Example: Er₂Ti₂O₇
Monazite structure: LBO₄
   ∘ Example: La_{0.995}Sr_{0.005}NbO₄
Sesquioxide structure:
   ∘ Example: doped Er₂O₃
Phosphate: LPO₄
   ∘ Example: LaPO₄
The oxygen-anion-conducting materials, and in particular those exhibiting one of the following structures:
Perovskite structure AB₁₋ₓMₓO₃:
   ∘ Example: La_{0.9}Ba_{0.1}Ga_{0.8}Mg_{0.2}O_{2.85}
Brownmillerite structure A₂B₂O₅:
   ∘ Example: Ba₂In₂O₅
Fluorite structure AO₂:
   ∘ Example: yttria-stabilized zirconia: (Zr,Y)O₂
Apatite structure: L₁₀M₆O₂₄
   ∘ Example: La₁₀Si₆O₂₇
Aurivillius structure (Bi₂O₂)(Aₙ₋₁BₙOₓ)
   ∘ Examples: Bi₃Nb_{0.1}Zr_{0.9}O_{6.55}, Bi₅TiNbWO₁₅, Bi₄Ti₃O₁₂
L₂Mo₂O₉ structure
   ∘ Example: La₂Mo₂O₉
Pyrochlorine structure L₂Zr₂O₇

In the generic formulae of the aforementioned structures, A designates an alkali element or alkaline-earth element, B and M designate transition metals pertaining to groups 3 to 14 of the periodic classification, and L designates a rare earth.

The first layer 2 is produced in such a way as to:
be constituted by linked elementary solid particles in contact with one another, the mean size of these elementary particles being less than 300 nm,
and to exhibit a total thickness less than 200 nm, typically of the order of 50 nm; a porosity by volume less than 10%, typically between 1% and 5%; and an ionic conductivity greater than or equal to 10⁻² S·cm⁻¹, typically of the order of 5.10⁻² S·cm⁻¹.

In order to do this, use may advantageously be made of a deposition process of sol-gel type. In such a process, precursors of the species that are capable of forming at least one mixed oxide are mixed in a neutral liquid medium, then this suspension is admixed to an organic polymeric matrix, then this mixture is applied onto the solid substrate, then the whole is subjected to a thermal treatment that is suitable to bring about the crystallisation of each mixed oxide and the decomposition of the organic polymeric matrix. With such a process, in particular the porosity of the layer obtained can be adjusted by varying the proportion of organic polymeric matrix in relation to the inorganic precursors. The molar ratio of the quantity of organic polymeric matrix to the quantity of the inorganic precursors is typically between four and six. The concentration of the precursors that are used in the initial suspension furthermore enables the total thickness of the layer that is formed to be controlled. In practice, this process may be implemented by any known technique, preferably in accordance with the technique known as dip coating, in which the solid substrate is immersed in the liquid mixture, then extracted from this mixture at a controlled speed, then subjected to a thermal treatment at high temperature, generally higher than 700° C.

In addition, in order to produce this first layer 2 use is preferably made of a material constituted by at least one mixed oxide chosen from the group of the

Ruddlesden-Popper phases corresponding to formula (I) with n−x≠1. More particularly, said material is chosen so that (n+1−x)/(n−y)<2.

Excellent results have been obtained with a first layer 2 constituted by a mixed oxide of formula L₂₋ₓNiO_{4+δ}, L being chosen from the group constituted by La, Pr, Nd.

At least one other different layer 3, 4 is superposed on this first layer 2. The number of superposed layers may be variable. However, the inventors have ascertained that, starting from a number of superposed layers greater than five, the performance data of the electrode are not appreciably improved. Consequently, an electrode according to the invention advantageously comprises a total number of superposed layers on the solid substrate amounting to between two and five.

Be that as it may, the various layers 3, 4 superposed on the first layer 2 are constituted by a material corresponding to the same family (formula (I)), preferably with identical elements L and M in all the layers of the same electrode, but solely by possibly varying, from one layer to the other, the proportions of the various elements in formula (I)—that is to say, the values of the parameters n, x, y and δ of formula (I).

In addition, the various layers 3, 4 superposed on the first layer 2 exhibit a different microstructure from that of the first layer 2. This variation of microstructures may result, in particular, from the use of a different process of deposition. The inventors have in fact ascertained that the materials corresponding to formula (I) can be deposited in accordance with different processes, and that the choice of the process that is used for the deposition enables the microstructure and in particular the porosity and the properties of electron conduction and ionic conduction of each deposited layer to be varied.

In particular, the last layer 4 of the electrode which comes into contact with the gas, notably with the air, is produced in such a way as to be constituted by elementary solid particles forming open pores between themselves and constituting an interconnected network of solid matter across its entire width, these elementary solid particles being linked in contact with one another, with a mean size of the elementary particles between 100 nm and 5 μm, typically of the order of 1 μm.

The thickness of the last layer 4 is advantageously between 1 μm and 5 μm.

Similarly, the thickness of each intermediate layer 3 superposed on the first layer 2 is advantageously between 1 μm and 5 μm.

The thickness of the various layers of the electrode, and in particular of the last layer 4 and of each intermediate layer 3 superposed on the first layer 2, is adjusted in such a way as to obtain an appropriate total thickness of the electrode.

This total thickness of the electrode has to be sufficient, on the one hand, to enable a sufficient electrocatalytic activity (this activity depending on the quantity of matter that the reactive species may come into contact with), on the other hand to exhibit good thermomechanical strength and to avoid short-circuits in operation. In order to do this, the total thickness of the electrode is greater than 1 μm, and preferably greater than 5 μm. Conversely, the total thickness of the electrode has to be as small as possible, in order to exhibit a resistivity that is not too high and in order to limit the manufacturing costs.

The invention enables the totality of these conditions to be satisfied with an electrode having a thickness that amounts to between 1 μm and 15 μm.

Accordingly, the total thickness of the electrode according to the invention is preferably between 1 μm and 15 μm.

The porosity by volume of the last layer 4 is between 10% and 50%, typically of the order of 30%. The last layer 4 is furthermore produced in such a way as to exhibit an ionic conductivity greater than 10⁻⁴ S·cm⁻¹ and an electron conductivity greater than 50 S·cm⁻³.

In order to obtain such structural characteristics, in particular the last layer 4 can be produced by a deposition of slip—that is to say, by producing a slip containing particles of mixed oxide(s) dispersed in suspension in a liquid medium, by applying this slip in the form of a layer, then by subjecting the whole to a treatment, notably a thermal treatment, that is suitable to bring about the evacuation of the liquid medium. Such a deposition of suspension charged with particles of mixed oxide(s) can be carried out in practice in accordance with various techniques known in themselves—for example, dip coating, spin coating, strip casting . . .

The liquid medium that is used in order to produce the slip may be an aqueous solvent or an organic solvent (for example, chosen from an alcohol, a ketone . . . ). The solid particles of each mixed oxide may themselves be obtained by sol-gel means, by preparing a suspension of salts of the precursor species in a solvent, by admixing an organic polymeric matrix to this suspension, then by subjecting the whole to a thermal treatment at a temperature between 700° C. and 1000° C. The choice of the temperature enables, in particular, the size of the particles of oxide(s) obtained to be influenced.

The particles obtained are dispersed in the liquid solvent, in order to form the slip. Advantageously, a certain minor proportion of at least one expanding agent, for example chosen from starch, carbon, a fluorocarbonated compound (for example PTFE) . . . is also added. Such an inert expanding agent is also eliminated in the course of the subsequent phase of thermal treatment.

The treatment for eliminating the liquid medium from the suspension may be a high-temperature calcination, typically at a temperature of the order of 1000° C. There is also nothing to prevent, in a variant or in combination, employing any other elimination treatment, for example by evaporation.

A non-cracked adherent homogeneous layer 4 is obtained exhibiting a thickness of the order of several microns.

It is also to be noted that, in a variant, the last layer 4 may be formed not by a deposition of slip but by a deposition also known as a deposition of charged sol. A deposition of charged sol differs from a deposition of slip in that the liquid medium contains, at the same time, solid particles of mixed oxide(s) and particles of precursor species of mixed oxide(s)—that is to say, in practice, particles of metallic salts, as in a deposition of sol-gel type. A deposition of charged sol also differs from a sol-gel deposition in that no organic polymeric matrix is added to the liquid suspension.

Excellent results have been obtained with a last layer 4 constituted by a mixed oxide chosen from the group constituted by LNiO₃, L₂₋ₓNiO_{4+δ},L₃Ni₂O_{7-δ} and L₄Ni₃O_{10-δ}, L being chosen from the group constituted by La, Pr, Nd.

At least one intermediate layer 3 may be interposed between said first layer 2 and said last layer 4. Such an intermediate layer 3 exhibits intermediate characteristics between those of the first layer 2 and those of the last layer 4, notably as far as its porosity and its properties of ionic conduction and of electron conduction are concerned. In particular, the porosity of the various layers increases from that of the first layer 2 to that of the last layer 4. In addition, the first layer 2 exhibits the greatest ionic conductivity, and the ionic conductivity decreases from that of the first layer 2 to that of the last layer 4. Conversely, the first layer 2 exhibits the lowest electron conductivity, and the electron conductivity increases from that of the first layer 2 to that of the last layer 4.

Each intermediate layer 3 preferably results from a deposition chosen from a deposition of slip and a deposition of charged sol—that is to say, is produced in accordance with a deposition process similar to that for the last layer 4. Accordingly, the microstructure of each intermediate layer 3 is similar to that of the last layer 4, and therefore different from that of the first layer 2.

A gas electrode according to the invention therefore exhibits a gradient of microstructure, of porosity and of composition across its thickness, from the solid substrate 1 as far as its free outer surface intended to be placed in contact with a gas.

Such a gas electrode according to the invention may serve as cathode for an electrochemical cell forming a solid-oxide fuel cell that is capable of converting chemical energy into electrical energy at an operating temperature between 600° C. and 800° C. In the cathode placed in contact with the air the gaseous oxygen is reduced to O²⁻ anions which diffuse across the electrolyte in order to react with the hydrogen released from the anode arranged on an opposite face of the electrolytic substrate. Such an anode may be formed from a porous ceramic-metal composite (commonly designated as ‘cermet’), for example a ceramic similar to that constituting the solid electrolyte, but in which a metal has been dispersed, for example metallic nickel.

### EXAMPLES

Six specimens of electrodes according to the invention were produced, labelled below respectively [1], [2], [3], [4], [5] and [6].

The experimental protocol for preparation of these specimens is the following.

Specimen [1]:

Preparation by Sol-Gel Deposition of the First Layer 2:

The first layer 2 is produced by dip coating of a substrate 1 formed from a pellet of polished yttria-stabilized zirconia (YSZ) with a diameter of 1 cm, at a controlled speed (3 cm/min) in a polymeric sol.

The sol is prepared on the basis of the protocol described by U.S. Pat. No. 3,330,697 (Péchini), and results from the mixing of precursors of the oxides, of type nickel nitrate and lanthanum nitrate, introduced in stoichiometric proportions. For this specimen, the precursors are introduced with a cationic ratio La³⁺/Ni²⁺ equal to 1.98, enabling the oxide La_{1.98}NiO_{4+δ} to be formed after annealing of the sol.

Organic agents are also added, notably acetylacetone, hexamethylenetetramine and acetic acid. After heating of the sol at 70° C. for about ten minutes so as to obtain an adequate viscosity (of the order of 30 mPa·s), the deposition is carried out.

The film of sol is then calcined in air at 700° C. for 2 h 00, with a slow rise in temperature (50° C./h), in order to eliminate the organic compounds and to proceed to crystallisation of the oxide.

Preparation by Slip Deposition of the Intermediate Layer 3:

The intermediate layer 3 is produced by dip coating of the YSZ substrate 1 covered by the first crystallized layer 2, at a controlled speed (3 cm/min) in a suspension.

The suspension is prepared from the dispersion of a ceramic powder of the oxide La₄Ni₃O₁₀ in an organic or aqueous medium. Said medium may contain various surfactants, such as a dispersing agent, a coupling agent and a plasticizing agent. Furthermore, the suspension may also contain an expanding agent. The ceramic powder is obtained by calcination of the polymeric sols in air at 1000° C. for 2 h. The suspension is homogenized, for example through the use of ultrasound.

The layer obtained is then calcined in air at 1000° C. for 2 h. In order to increase the thickness of this porous layer, several depositions may be carried out and/or the charge of ceramic particles may be increased.

Preparation by Slip Deposition of the Last Layer 4:

The last layer 4 is prepared in the same manner as the intermediate layer 3, but with a powder, the composition of which is La₂NiO_{4+δ}.

Specimen [2]:

The first layer 2 of this specimen is produced as indicated above for specimen [1], but with a cationic ratio La³⁺/Ni²⁺ equal to 1.33, enabling the oxide La₄Ni₃O₁₀ to be formed after annealing of the sol.

The intermediate layer 3 is prepared as described above in the case of specimen [1].

The last layer 4 is prepared by deposition of slip as described above in the case of specimen [1], with a powder, the composition of which is LaNiO₃. In order to obtain grains with a diameter greater than one micron, the powder is annealed in air at a temperature higher than the calcination temperature of the sols, for example 1200° C., and/or for a duration of temperature plateau longer than 2 h, for example 10 h.

Specimen [3]:

The first layer 2 is prepared as described above in the case of specimen [1].

The intermediate layer 3 is prepared as described above in the case of specimen [1], but using a powder, the composition of which is La₂NiO_{4+δ}.

The last layer 4 is prepared as described above in the case of specimen [2], but with a powder, the composition of which is La₄Ni₃O₁₀.

Specimen [4]:

The first layer 2 is produced by a sol-gel deposition as described above in the case of specimen [1], but with a mixture of nickel nitrate and neodymium nitrate which are introduced with a cationic ratio Nd³⁺/Ni²⁺ equal to 1.95.

The total molar ratio of the Nd³⁺ and Ni²⁺ cations to the chelating agent (the acetylacetone) is fixed at 3. The molar ratio of the acetylacetone to the hexamethylenetetramine is fixed at 1.

Three depositions were carried out with a step of calcination at 700° C. after each deposition.

The last layer 4 of this specimen [4] (which comprises only two layers 2, 4 stacked on the substrate 1) is produced by a deposition of slip, with a slip formed from 10 g of Nd_{1.95}NiO₄ powder dispersed in 15 g of solvent. The solvent is an azeotropic mixture of methyl ethyl ketone and ethanol (66/34% by volume). The slip also contains 100 mg of a commercial dispersing agent labelled C213 and 1 g of binder of type polyethylene glycol. The last porous layer 4 is deposited on the first layer 2, and the specimen is calcined in air at 1000° C. for 1 h, with a brief plateau at 400° C. The rate of heating is 1° C./min up to 400° C., then 5° C./min up to 1000° C.

Specimen [5]:

The first layer 2 of this specimen is produced by a sol-gel deposition as described in the case of specimen [4] with a mixture of nickel nitrate and neodymium nitrate which are introduced with a cationic ratio La³⁺/Ni²⁺ equal to 1.98. Organic agents are also added, such as acetylacetone, hexamethylenetetramine and acetic acid. The total molar ratio of the La³⁺ and Ni²⁺ cations to the chelating agent (the acetylacetone) is fixed at 3. The molar ratio of the acetylacetone to the hexamethylenetetramine is fixed at 1.

The film of sol is then calcined in air at 700° C. for 2 h 00, with a slow rise in temperature (50° C./h). Three depositions were carried out, with, after each deposition, a step of calcination at 700° C. with a rate of rise in temperature of 100° C./h.

The second and last porous layer 4 of this specimen is produced by a deposition of slip constituted by 10 g of powder of mixed oxide La₄Ni₃O₁₀ dispersed in 15 g of solvent. The solvent is an azeotropic mixture of methyl ethyl ketone and ethanol (66/34% by volume). The slip also contains 100 mg of a commercial dispersing agent labelled C213 and 1 g of binder of polyethylene-glycol type. The porous layer 4 is deposited on the first layer 2, and the specimen is calcined in air at 1000° C. for 1 h, with a brief plateau at 400° C. The rate of heating is 1° C./min up to 400° C., then 5° C. /min up to 1000° C.

Specimen [6]:

The first layer 2 of this specimen is prepared as described above in the case of specimen [4].

The second and last porous layer 4 of this specimen is prepared by deposition of slip as described above in the case of specimen [5].

The table below shows the principal characteristics of the various specimens.

FIGS. 1 to 3 are sketches illustrating the microstructure of the electrodes according respectively to specimens [1], [2] and [3].

Furthermore, measurements of impedance were carried out on specimens [4] to [6]. The total conductivity of the half-cells forming the specimens was measured by complex-impedance spectroscopy, a technique that enables the contributions of the electrolyte and of the electrode reaction (this latter being linked to the material constituting the electrode and to the architecture of the various depositions) to be separated. The measurements were recorded by a Solartron® 1260 impedometer and processed by Z-View® software. The amplitude of the a.c. voltage was fixed at 50 mV. The measurements were carried out in atmospheric air for temperatures between 100° C. and 800° C. and for frequencies varying from 10⁶ Hz to 10⁻² Hz or 5.10⁻³ Hz. The polarisation resistance of the cathode is determined on the basis of extrapolation on the axis of the real components of the electrical contributions apparent at the medium and low frequencies. These two contributions are generally capable of being modelled by two adjacent or superposed semicircles in the mode of representation by Nyquist diagrams. The area-specific polarisation resistance ASR, the value of which is represented in FIG. 4, is determined by the formula:

ASR=Rp·S/2

where S is the macroscopic area of the free surface of the electrode in contact with the air.

As can be seen in FIG. 4, specimens [4], [5], and [6] according to the invention all operate at 700° C., and, for some, even at a lower temperature, which may be as low as 650° C., and all exhibit a very satisfying value of area-specific polarisation resistance, of the order of 1 Ω·cm² at 800° C.

Moreover, it is ascertained that the specimens according to the invention exhibit a stable chemical resistance. This result is supported, notably, on tests of reactivity carried out on the basis of calcination at 800° C. in air during 3 weeks of pulverulent mixing of the YSZ oxides, electrolyte material, and of the mixed oxides of formula (I). No parasitic phase was observed subsequent to this experimentation. Furthermore, similar tests were carried out on layers, and led to the same results. Lastly, studies carried out with electrolyte materials that were conductors of protons, of type LBO₄, led to the same results. The analysis of the specimens tested was carried out by X-ray diffraction of the pulverulent mixtures and of the surfaces of the various layers, as well as by microscopic studies coupled with studies by electron-dispersion spectroscopy which were carried out on sliced sections of the electrochemical cells.

Accordingly, the various specimens according to the invention are largely compatible with use in a fuel cell, for example. The materials constituting an electrode according to the invention and the methods of manufacture implemented are furthermore economical and may be produced and carried out on an industrial scale under good conditions of cost-effectiveness.

| | specimen | | | | | |
|---|---|---|---|---|---|---|
| | [1] | [2] | [3] | | | |
| | FIG. 1 | FIG. 2 | FIG. 3 | [4] | [5] | [6] |
| solid substrate | yttria- | yttria- | yttria- | yttria- | yttria- | yttria- |
| | stabilized | stabilized | stabilized | stabilized | stabilized | stabilized |
| | zirconia | zirconia | zirconia | zirconia | zirconia | zirconia |
| first layer | La₂₋ₓNiO₄ | La₄Ni₃O₁₀ | La₂₋ₓNiO₄ | Nd_{1.95}NiO₄ | La_{1.98}NiO₄ | Nd_{1.95}NiO₄ |
| deposition process | sol-gel | sol-gel | sol-gel | sol-gel | sol-gel | sol-gel |
| grain size | 200 nm | 200 nm | 200 nm | | | |
| porosity | 10% | 10% | 10% | | | |
| thickness | 300 nm | 300 nm | 300 nm | | | |
| intermediate layer | La₄Ni₃O₁₀ | La₄Ni₃O₁₀ | La₂NiO₄ | — | — | — |
| deposition process | slip | slip | slip | — | — | — |
| grain size | 1 to 3 μm | 1 to 3 μm | 1 to 3 μm | — | — | — |
| porosity | 30% | 30% | 30% | — | — | — |
| thickness | 7 μm | 7 μm | 5 μm | — | — | — |
| last layer | La₂NiO₄ | LaNiO₃ | La₄Ni₃O₁₀ | Nd_{1.95}NiO₄ | La₄Ni₃O₁₀ | La₄Ni₃O₁₀ |
| deposition process | slip | slip | slip | slip | | |
| grain size | 1 to 3 μm | 3 to 5 μm | 3 to 5 μm | | | |
| porosity | 40% | 40% | 40% | | | |
| thickness | 7 μm | 10 μm | 10 μm | | | |

FIGS. 5a, 5b, 5c, 5d represent electron-microscope photographs of various parts of specimen [4] according to the invention.

FIGS. 5a, 5b, 5c represent the interface between the first layer 2 and the last layer 4 which is superposed thereon, with a variable magnification (×2000, ×5000 and ×10,000, respectively). FIG. 5d shows the interface between the electrolyte 1 and the first layer 2. As can be seen, the first layer 2 is porous, but less porous than the last layer 4. It is ascertained, in addition, that the various structural characteristics mentioned above are definitely obtained.

It goes without saying that the invention may be the object of very numerous embodiment variants in relation to the single embodiments described and represented in the Figures. In particular, the number of layers may vary. For each layer deposited, it is easy to adjust the characteristics of each deposition step in order to obtain the desired porosity and the appropriate properties of ionic conduction and electron conduction.

1. Gas electrode comprising a plurality of layers stacked on top of one another on the basis of a solid substrate such as a solid electrolyte, the various layers being suitable to enable the passage of reactive species across the thickness of this electrode, and comprising a first layer in contact with said solid substrate and a last layer exhibiting a free outer surface intended to be placed in contact with a gas, each of said layers being constituted by at least one mixed oxide,
wherein:
each of said layers is constituted by at least one mixed oxide chosen from the group constituted by the perovskites and by the Ruddlesden-Popper phases corresponding to the following general formula (I):
Lₙ₊₁₋ₓNi_{n-y}M_{y}O_{3n+1±δ}
where L is an element chosen from the group of the rare earths, Ni represents nickel, M is a transition metal, n is a non-zero integer, x, y and δ are real numbers satisfying the following relations:
0≦x<n+1
0≦y<n
0≦δ≦0.25,
said first layer is constituted by at least one mixed oxide chosen from the group of the Ruddlesden-Popper phases corresponding to formula (I),
the microstructure of said first layer is different from the microstructure of said last layer,
the porosity of the various layers increases from said first layer, the porosity of which is the lowest, to said last layer, the porosity of which is the most substantial,
the various layers stacked on top of one another form a network of interconnected solid matter between the free outer surface of the last layer and the solid substrate, exhibiting a total thickness greater than 1 μm.

2. Electrode as claimed in claim 1, wherein the microstructure of said first layer is different from the microstructure of the superposed layer in contact with this first layer.

3. Electrode as claimed in claim 1, wherein the difference in microstructures is due to different proportions for the various elements constituting the material.

4. Electrode as claimed in claim 1, wherein said last layer is constituted by at least one mixed oxide chosen from the group constituted by the perovskites and by the Ruddlesden-Popper phases corresponding to formula (I), and all the other layers are constituted by at least one mixed oxide chosen from the group constituted by the Ruddlesden-Popper phases corresponding to the general formula (I).

5. Electrode as claimed in claim 1, wherein each of the layers is constituted by at least one mixed oxide chosen from the group constituted by the Ruddlesden-Popper phases corresponding to the general formula (I), and wherein elements L and M are the same for all said layers of the electrode.

6. Electrode as claimed in claim 1, wherein L is an element chosen from the group constituted by La, Pr, Nd, Sm, Eu, Er and Gd, and M is a transition metal chosen from the group constituted by Fe, Co and Mn.

7. Electrode as claimed in claim 1, wherein n−x≠1 holds for said first layer.

8. Electrode as claimed in claim 1, wherein (n+1−x)/(n−y)<2 holds for said first layer.

9. Electrode as claimed in claim 1, wherein said first layer is constituted by a mixed oxide of formula L₂₋ₓNiO_{4+δ}, L being chosen from the group constituted by La, Pr, Nd.

10. Electrode as claimed in claim 1, wherein said last layer is constituted by a mixed oxide chosen from the group constituted by LNiO₃, L₂₋ₓNiO_{4+δ}, L₃Ni₂O_{7-δ} and L₄Ni₃O_{10-δ}, L being chosen from the group constituted by La, Pr, Nd.

11. Electrode as claimed in claim 1, wherein said first layer is constituted by linked elementary solid particles in contact with one another, the mean size of these elementary particles being less than 300 nm.

12. Electrode as claimed in claim 1, wherein the thickness of said first layer is less than 200 nm, notably of the order of 50 nm.

13. Electrode as claimed in claim 1, wherein said last layer is constituted by elementary solid particles forming open pores between themselves and constituting an interconnected network of solid matter across its entire thickness.

14. Electrode as claimed in claim 1, wherein said last layer is constituted by linked elementary solid particles in contact with one another, the mean size of these elementary particles being between 100 nm and 5 μm.

15. Electrode as claimed in claim 1, comprising between two and five layers stacked on the solid substrate, the various stacked layers exhibiting a total thickness between 1 μm and 15 μm.

16. Electrode as claimed in claim 1, wherein said first layer exhibits a porosity less than 10% by volume.

17. Electrode as claimed in claim 1, wherein said last layer exhibits a porosity greater than 10% and less than 50% by volume.

18. Electrode as claimed in claim 1, exhibiting a plurality of layers superposed on said first layer in contact with the solid substrate, the porosity of said electrode increasing from said first layer to said last layer.

19. Electrode as claimed in claim 1, wherein each of said layers results from at least one deposition chosen from a deposition of slip, a deposition of charged sol, and a sol-gel deposition.

20. Electrode as claimed in claim 18, wherein at least one intermediate layer between said first layer and said last layer results from at least one deposition chosen from a deposition of slip and a deposition of charged sol.

21. Electrode as claimed in claim 19, wherein said first layer results from at least one sol-gel deposition.

22. Electrode as claimed in claim 19, wherein said last layer results from at least one deposition chosen from a deposition of slip and a deposition of charged sol.

23. Electrode as claimed in claim 1, wherein amongst the various layers said first layer exhibits the greatest ionic conductivity.

24. Electrode as claimed in claim 1, wherein said first layer is constituted by a material, the ionic conductivity of which is greater than or equal to 10⁻² S·cm⁻¹.

25. Electrode as claimed in claim 1, wherein said last layer is constituted by a material, the ionic conductivity of which is greater than 10⁻⁴ S·cm⁻¹, and the electron conductivity of which is greater than 50 S·cm⁻¹.

26. Method for manufacturing a gas electrode in which a plurality of layers are stacked on top of one another on the basis of a solid substrate such as a solid electrolyte, the various layers being produced in order to enable the passage of reactive species across the thickness of this electrode and comprising a first layer in contact with said solid substrate and a last layer exhibiting a free outer surface intended to be placed in contact with a gas, each of said layers being constituted by at least one mixed oxide, wherein:
each of said layers is produced in such a way that it is constituted by at least one mixed oxide chosen from the group constituted by the perovskites and by the Ruddlesden-Popper phases corresponding to the following general formula (I):
Lₙ₊₁₋ₓNi_{n-y}M_{y}O_{3n+1±δ}
where L is an element chosen from the group of the rare earths, Ni represents nickel, M is a transition metal, n is a non-zero integer, x, y and δ are real numbers satisfying the following relations:
0≦x<n+1
0≦y<n
0≦δ≦0.25,
said first layer is produced in such a way as to be constituted by at least one mixed oxide chosen from the group of the Ruddlesden-Popper phases corresponding to formula (I),
said first layer is produced in accordance with a deposition process different from the process of deposition with which said last layer is produced, so that:
the microstructure of said first layer is different from the microstructure of said last layer,
the porosity of the various layers increases from said first layer, the porosity of which is the lowest, to said last layer, the porosity of which is the most substantial,
the various stacked layers are produced in such a way that they form a network of interconnected solid matter between the free outer surface of the last layer and the solid substrate, exhibiting a total thickness greater than 1 μm.

27. Method as claimed in claim 26, wherein said first layer is produced in accordance with a deposition process different from the process of deposition of the superposed layer in contact with this first layer.

28. Method as claimed in claim 26, wherein said first layer is deposited on the solid substrate by at least one sol-gel deposition in which precursor species intended to form at least one mixed oxide are mixed in a solvent, then the suspension is admixed to an organic polymeric matrix, then this mixture is applied onto the solid substrate, then the whole is subjected to a thermal treatment that is suitable to bring about the crystallisation of each mixed oxide and the decomposition of the organic polymeric matrix.

29. Method as claimed in claim 26, wherein said last layer is applied by carrying out at least one deposition of slip in which a slip is produced containing solid particles of at least one mixed oxide which are dispersed in a liquid medium, then this slip is applied in the form of at least one layer, then the whole is subjected to a treatment that is suitable to bring about the evacuation of the liquid medium.

30. Method as claimed in claim 26, wherein said last layer is applied by carrying out at least one deposition of charged sol in which a suspension is produced containing solid particles dispersed in a liquid solution of precursors of species intended to form at least one mixed oxide, then this suspension is applied in the form of at least one layer, then the whole is subjected to a treatment that is suitable to bring about the deposition and the crystallisation of the mixed oxides and the evacuation of the liquid phase.

31. Method as claimed in claim 26, wherein between two and five layers are deposited onto the solid substrate, the various stacked layers exhibiting a total thickness between 1 μm and 15 μm.

32. Method as claimed in claim 26, wherein the solid substrate is a gastight solid electrolyte chosen from the group constituted by ceramics that are conductors of O²⁻ anions and by ceramics that are conductors of protons.

33. Electrochemical cell comprising at least one gas electrode, comprising at least one gas electrode as claimed in claim 1.

34. Electrochemical cell of a fuel cell, comprising a solid electrolyte bearing a cathode formed by an air electrode as claimed in claim 1.

35. Electrochemical cell as claimed in claim 33, wherein the gas electrode exhibits a plane shape overall.

36. Electrochemical cell as claimed in claim 33, exhibiting a cylindrical shape overall, notably cylindrical in revolution.
